(19) United States
(12) Patent Application Publication
(10) Pub. No.: US 2008/0068401 A1
(43) Pub. Date: Mar. 20, 2008

(54) BROWSER CREATION OF GRAPHIC DEPICTING RELATIONSHIPS

(75) Inventors: Paul Albrecht, Bedford, MA (US); Paul Grimshaw, Acton, MA (US); Joseph G. Hadzima, Wellesley, MA (US); Hoo-min D. Toong, Cambridge, MA (US)

Correspondence Address: BERKELEY LAW & TECHNOLOGY GROUP, LLP, 17933 NW Evergreen Parkway, Suite 250, BEAVERTON, OR, 97006, US

(73) Assignee: Technology Enabling Company, LLC, Cambridge, MA (US)

(21) Appl. No.: 11/532,092

(22) Filed: Sep. 14, 2006

(51) Int. Cl. G09G 5/00

(52) U.S. Cl. 345/645

(57) ABSTRACT

A method and/or system for creating a graphic to depict relationships via a browser is disclosed.

### FIELD

This disclosure is related to creation of graphic, such as those depicting relationships among a set of elements, using a browser.

### BACKGROUND

Software for browsing, such as for browsing stored data and/or for web-browsing, is well-known. Although at times convenient, this approach to presenting data has some disadvantages. For example, it may be difficult to provide end-users with features of an interface typically associated with a software application, such as, for example, context sensitive pop-up menus and/or other graphical features, referred to here as graphical application-like interface features. A reason for this at least in part is the use of HTML to layout text, images and/or other data on a page, such as a web page. HTML is not convenient to use in providing such features.

One approach to address this issue is the use of browser or web-browser “plug-ins.” Here, this refers to software that operates in conjunction with web-browser software to provide a desired graphical application-like interface. However, employing such software raises other issues, such as security concerns and/or work-flow issues in connection with use of the browser, for example.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a schematic diagram illustrating an embodiment of a patent family map or graph;

FIG. 2 is a schematic diagram illustrating an aspect or feature of the embodiment shown in FIG. 1;

FIG. 3 is a schematic diagram illustrating another aspect or feature of the embodiment shown in FIG. 1;

FIGS. 4A, 4B, and 4C are schematic diagrams illustrating additional aspects or features of the embodiment shown in FIG. 1;

FIG. 5 is a screen shot illustrating PAIR data available for a patent asset from the website for the US Patent and Trademark Office;

FIG. 6 is another screen shot illustrating PAIR data available for a patent asset from the website for the US Patent and Trademark Office;

FIG. 7 is yet another screen shot illustrating PAIR data available for a patent asset from the website for the US Patent and Trademark Office;

FIGS. 8-13 are schematic diagrams illustrating possible embodiments of a graphic that may be employed to illustrate relationships between assets for an embodiment of a patent family map or graph;

FIGS. 14-16 are schematic diagrams illustrating another embodiment of a patent family map or graphic;

FIGS. 17-20 are schematic diagrams illustrating yet another embodiment of a patent family map or graphic;

FIG. 21 is a flowchart illustrating one embodiment of an auto-binning technique;

FIGS. 22 and 23 are tables providing pseudocode for an embodiment of a technique for creating a blinking effect using HTML;

FIGS. 24-26 are schematic diagrams illustrating the embodiment of FIGS. 22 and 23;

FIG. 27 is a flowchart illustrating an embodiment of a semi-automated approach to searching electronic documents;

FIG. 28 is a schematic diagram illustrating the embodiment of FIG. 27; and

FIG. 29 is a schematic diagram illustrating an alternate embodiment of a semi-automated approach to searching electronic documents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter.

Some portions of the detailed description which follow are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing may involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices.

As previously alluded to, Hypertext Markup Language (HTML) has become a universal language that has enabled rapid growth and standardization of the Web. However, unfortunately, the language is not designed for creating graphical application-like features. HTML derives from a document markup language, Standard Generalized Markup Language (SGML), which is not a user-interface design language. HTML is, therefore, focused on the layout of text input and text output elements and the layout of images, but not on creating graphical operations including intricate operations. Hence, the interactive functionality that is possible in a graphical application executing on a state-of-the art computing platform, for example, has not generally been seen using HTML-based pages, such as web pages.

A common workaround for this issue has been the creation of plug-ins for browsers. The plug-ins work with the browser through a prescribed plug-in application programming interface (API). The browser typically employs a set screen area to allocate for the plug-in, but is not typically involved in determining the contents of the screen area. An example of a common plug-in used to deliver graphical content or game applications include Flash or Shockwave software, available, for example, from Macromedia. Commonly, plug-ins for Internet Explorer are designed using ActiveX controls. Java counterparts to ActiveX controls are referred to as applets. Applets are generally supported by common browsers, such as Netscape and Internet Explorer. An issue with ActiveX controls and Java Applets is that they are downloaded to the particular computing platform before being used to render graphical content. This may have security implications and/or workflow implications, for example.

For Internet Explorer, for example, the ActiveX controls may access many elements of the particular computing platform and may make modifications, capture and/or transmit information back to a service via the Internet—sometimes without the platform user's knowledge. Thus, it is not unusual for ActiveX controls from some web sites to load spy ware and/or ad-ware onto a user's computing platform. Thus, the particular computing platform user may be taking some risk if a plug-in is downloaded.

Likewise, the use of plug-ins may make workflow more cumbersome for a user. Downloading a plug-in for a particular application may take many minutes. For example, for applications that are being routinely updated, this may involve downloads if an application is used or changed.

In contrast, HTML does not have the security and workflow issues associated with plug-ins. However, the absence of a convenient method for creating graphical application-like features in HTML has impeded its use in certain computing environments. Further complicating the task is that different browser software may not interpret HTML pages the same way. What follows is a description of particular embodiments of a method and/or system of using a browser, such as a web-browser, to create maps or another graphic to be displayed having application-like features that depicts relationships visually. In this particular embodiment, application-like features includes an HTML-based application, for example. However, it is appreciated that claimed subject matter is not limited in scope to the embodiments described, such as HTML, for example. These embodiments are merely provided as examples of possible implementations within the scope of claimed subject matter. It is specifically intended that subject matter claimed be broader and more encompassing than simply the particular embodiment, described. It is also noted that any subject headings and/or other transitions in the material that follows are merely provided for the convenience of the reader and are not intended to limit the scope of claimed subject matter in any way.

In this context, the term HTML document refers to any content in any form, such as an electronic form, that is provided in a format that is HTML compatible or readable. HTML elements used in the <body> of an HTML document are classified for this particular embodiment as either block-level elements or inline elements. Inline elements typically may include text and other inline elements. If rendered visually, inline elements do not usually begin on a new line. Block-level elements typically include inline elements and other block-level elements. Block-level elements usually begin on a new line.

One example of a graphic that may prove desirable relates to depicting relationships among intellectual property (IP) assets. A reason this may be helpful is because in connection with various types of IP, who originated the IP and when may have consequences. Therefore, it is common to refer to related IP either for legal or informative reasons. In this context, the term intellectual property assets in general refers to, without limitation, any form of IP current recognized or to be recognized in any country of the world. Examples include: any and all issued patents and/or patent applications, including utility or design patents, for example; utility models; copyrights; trademarks; service marks; trade secrets; trade names; publications and more.

Likewise, it is common to refer to families of IP assets, particularly in connection with patents and/or patent applications. However, there is no uniform definition of a patent family. In general, a patent family refers to related patents and/or patent applications, but how they are related to be included in a “patent family,” for example, may vary. It is intended to include any and all such variations now used or to be developed later within the scope of claimed subject matter. Furthermore, depending, for example, on the particular context, there may be reasons to graphically depict differences between similar but not identical definitions of a family with respect to a given set of IP assets.

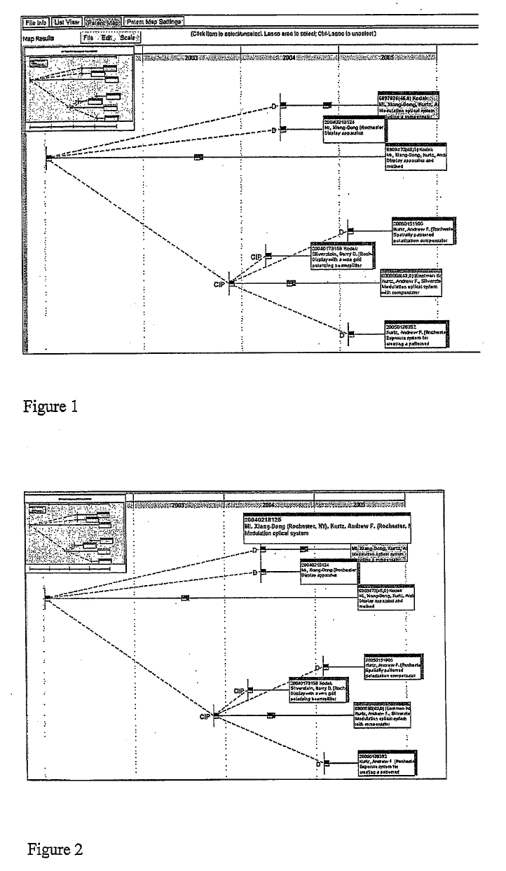

FIG. 1 is one possible embodiment of such a graphic or map, although claimed subject matter is not limited in scope to this particular example embodiment. The graphic resembles the embodiments disclosed in, for example, U.S. patent application Ser. No. 11/096,561 (attorney docket number 023.P015), entitled “GRAPHICAL VISUALIZATION OF DATA PRODUCT USING BROWSER,” filed on Apr. 1, 2005, by Albrecht et al.; and/or U.S. patent application Ser. No. 11/096,931 (attorney docket number 023.P004), entitled “APPARATUS FOR CREATING GRAPHICAL APPLICATION INTERFACE,” filed on Apr. 1, 2005, by Albrecht et al., both assigned to the assignee of the present patent application, such as those which are time based, namely that the X axis is time and the objects on the map are aligned in the X dimension with their left edges corresponding to a point in time. Of course, claimed subject matter is not limited in scope to such an approach or to the embodiments disclosed previously. This is merely a helpful point of reference for discussion of potential approaches.

In FIG. 1, for this embodiment, the large rectangular boxes have a “tail” to the left. The vertical line on the “tail” corresponds to the filing date of a patent application. In FIG. 1, the topmost box is shaded in its body. This depicts an issued US patent in this example. The tail has a smaller box on it, which corresponds to the published application relating to the issued US patent. If a cursor is placed over the small box, an enlarged version of the box is shown in a “hover window” as illustrated, for example, in FIG. 2. Again, claimed subject matter is not limited in scope to this particular embodiment. Many variations are possible and intended to be included within the scope of claimed subject matter.

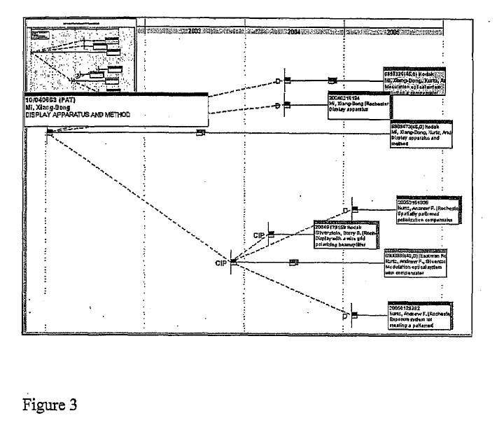

In this particular embodiment, dotted lines show the relationship between objects. For example, in FIG. 3 (which is another view of the embodiment as shown in FIG. 2) the small box on the leftmost “tail” is the initial patent application for this particular patent family. The box has the notation “(PAT)” in the first line to indicate that the application resulted in a patent. Other notations may be used to indicate to the user the current status of the patent application, e.g. (AB) for Abandoned, (PEND) for Pending, etc. Again, these are example notations and claimed subject matter is not limited in scope to employing these particular notations.

In FIG. 3, there are three dotted lines illustrated leading out of the initial patent application. These connect to the tails of other patents and published patent applications. This indicates that the initial patent application spawned three other patent applications. The top 2 dotted lines in FIG. 3 have a “D” at their rightmost end, indicating that these two patent applications are “Divisionals” of the initial patent application. The third line has a “CIP” at its rightmost end, indicating that the third patent application is a “Continuation in Part” of the initial patent application. Other appropriate symbols may be shown in a similar fashion, e.g. a “C” for a “Continuation” patent application. Again, these are example notations and claimed subject matter is not limited in scope to employing these particular notations.

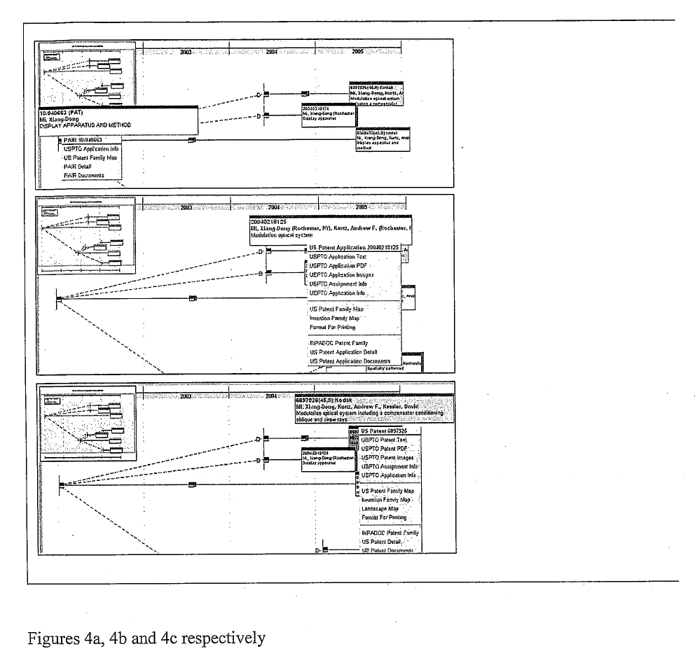

As for some embodiments described in the previously referenced patent applications, for example, right clicking on an object brings up an action menu which is context specific to the object. FIG. 4 illustrates embodiments for menus for an unpublished patent application (4A), a published patent application (4B) and an issued patent (4C). Again, these previously described embodiments are referenced for convenience only. Claimed subject matter is not limited to these or to any other particular embodiments.

For this particular embodiment, graphics, such as the embodiments illustrated in the previously referenced figures, are constructed from a variety of available data sources. These include a variety of website including the website of the United States Patent and Trademark Office, the website of the European Patent Office and others. Of course claimed subject matter is not limited in scope to a particular data source. For example, private and public sources may be employed. Likewise, sources that provide information without charge and sources that provide information for a fee may be used.

Starting with an issued patent number, a published patent application or an unpublished application, data may be assembled from such sources to be displayed on a graphic. Since there may be multiple patent applications being prosecuted in a particular family at any time it is desirable for accuracy that the most recently available data be used. As indicated above, one publicly available data source is the United States Patent and Trademark Office website, which provides links to PAIR (Patent Application Information Retrieval) System (http://portal.uspto.gov/external/portal/pair), although claimed subject matter is not limited to using PAIR or only using PAIR, as previously indicated. Nonetheless, out of convenience, below we describe this particular embodiment with reference to PAIR. It is understood that this description is not meant to be limiting.

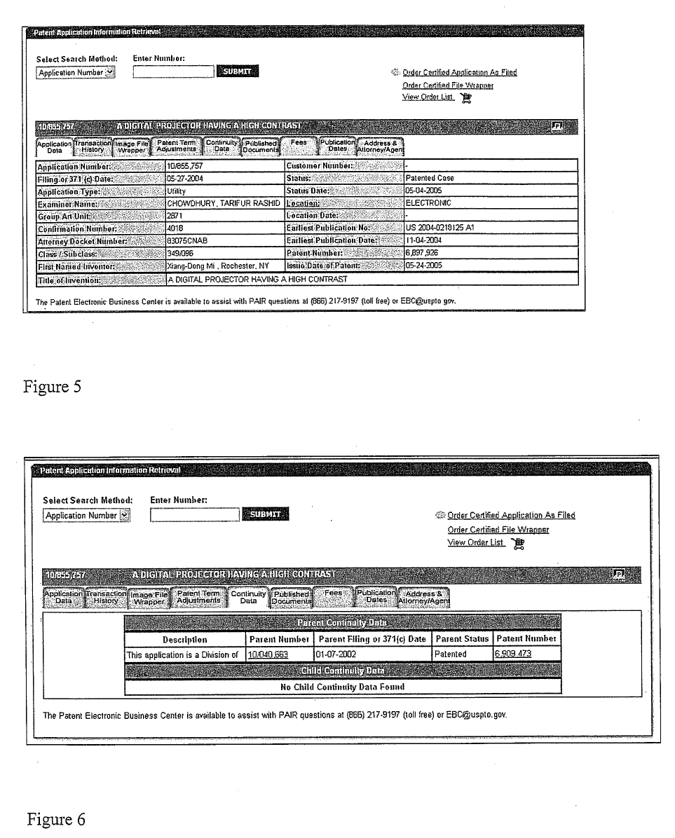

One method of assembling data to construct a graphic, such as those previously described, for example, is to use the USPTO PAIR System and “walk” through the patent continuity data available. For example, the graphics shown in FIGS. 1 thru 4 were generated from data for U.S. Pat. No. 6,897,926. FIG. 5 shows the first “page” of the PAIR information for this starting patent. This patent was the result of patent application Ser. No. 10/855,777, as illustrated from the information shown in FIG. 5.

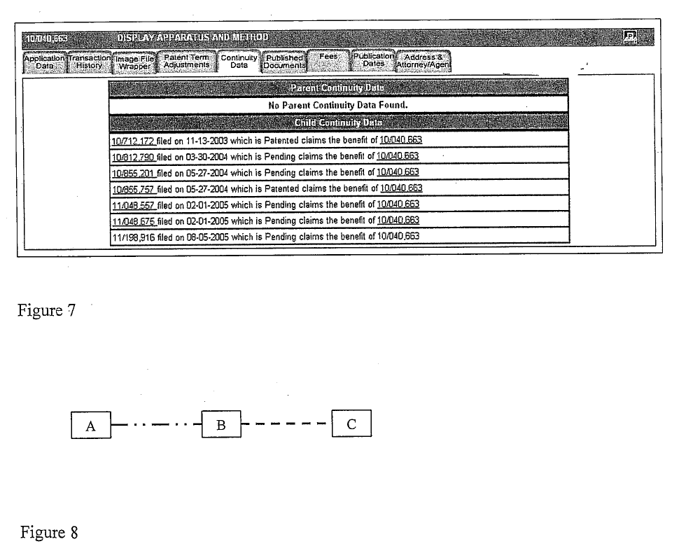

Information to construct the previously illustrated graphics, for example, may be found under the tab labeled “Continuity Data” in FIG. 5. IF this tab is “clicked” the information displayed, as shown in FIG. 6. Continuity Data for U.S. Pat. No. 6,897,926 shows that its parent is patent application Ser. No. 10/040,663 and that the application which resulted in U.S. Pat. No. 6,897,926 is a “Divisional” of patent application Ser. No. 10/040,663. FIG. 7 shows the corresponding Continuity Data tab for patent application Ser. No. 10/040,663.

In this particular example, patent application Ser. No. 10/855,757 is one of many “children” of patent application Ser. No. 10/040,663. Likewise, patent application Ser. No. 10/040,663 has no Parent, indicating that it is the “initial patent application” for this particular family. Appropriate processes may be employed to trace through the linkages between parents and children in order assemble the data for constructing the graphics shown in FIGS. 1 thru 4.

However, at times, different aspects of the data may be inconsistent or have other anomalies. Below, different approaches to handling this through graphics are described. It is noted that these are examples for one particular embodiment and claimed subject matter is not limited to employing only these approaches. Other approaches instead of and/or in addition the following are possible and intended to be included within the scope of claimed subject matter.

In some situations, for example, the PAIR system or other data source may be missing an item. For example, assume:

A lists B as child (usually w/date & status)

B is not available in PAIR

In this case, for example, in one particular embodiment, an icon such as a box, for example, may be displayed on a graphic in an appropriate X dimension location to represent the known date of the missing entry. Likewise, text may be inserted in the box to represent whatever information is known about the entry. Furthermore, a Right Click Action Menu may be attached to the object even if there is no underlying data item to access. One advantage of having a Right Click Action Menu attached is providing the ability for a user to access the data if and when it is made available. In addition, if there is no date data about the missing object, the object may still be presented on a graphic in a separate “zone” so the user sees that there is data missing, as explained in more detail below.

In another situation, a data source may be inconsistent as to parent and child relationships. For example, assume:
A lists C as a descendant, but NOT B
C lists B as parent, and A as grandparent
B lists NO parent and B lists C as a descendant
   We note that the phrase “Child Continuity Data” is used by the USPTO. However, items under this label may include children, grandchildren, etc. There is no way to tell directly from this what the specific relationship is between the starting patent and the “children” listed. In this context, therefore, we will use the term “descendant” instead of “child.” Continuing with this example, in one particular embodiment, if a connection cannot be confirmed by checking a descendent and the matter from which the descendent is to have descended then the connection may be shown using a different line type. Doing so points out an inconsistency and draws a reviewer's attention to a potential problem. In the example given above, there would be a different dotted line between A and B, as illustrated, for example, in FIG. 8.

In another situation, a parent-child link may be missing, resulting in an incorrect part-child relationship being indicated. Assume the following:
A lists C as a descendant, but NOT B
B lists D as parent, NOT A and B lists C as a descendant
C lists B as parent, and A as grandparent
D lists B as a descendant
   In this case, as the links are investigated and confirmed by the data, they may be drawn to indicate whether or not the data is consistent. Below is an example of how this might be accomplished for this particular example.

### 1: Determine links declared by A: “A lists C as a descendant”

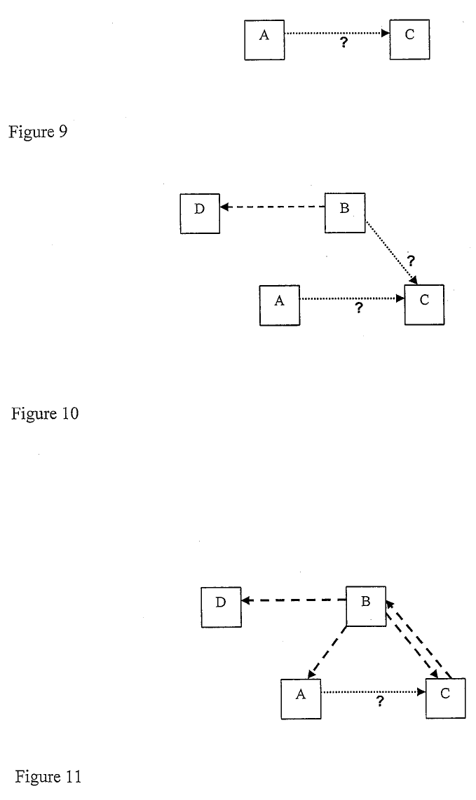

### In this case, we do not yet know for sure the exact relationship between A and C so it is tagged with a question (7), as illustrated in FIG. 9.

### 2: Determine links declared by B: “B lists D as parent and B lists C as a descendant”

Again, because we do not yet know for sure about the integrity the B-C relationship, we will tag it with a “?” However, here B has declared an exact relationship between it and D, that D is its parent. Because, this is unambiguous we show this as an unambiguous declaration by B, which we will confirm later step by investigating D's declaration. This is illustrated in FIG. 10.

### 3: Determine links declared by C: “C lists B as parent and A as grandparent”

### Now we know that the relationship between B and C is a parent-child relationship and we convert the “?” to an unambiguous link, as illustrated in FIG. 11.

### 4: Determine links declared by D: “D lists B as a descendant”

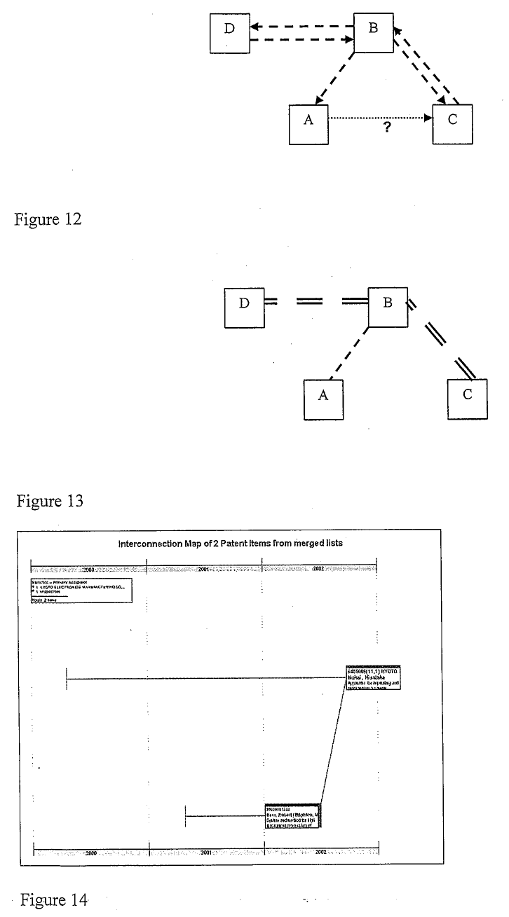

Here, we already know that B has declared D to be its parent so we can confirm the relationship, as illustrated in FIG. 12. There are no other relationships to explore, so as a result of this process, we are able to confirm the D-B and the B-C links. We have no confirmation from C that A is its parent, but C has declared A to be its grandparent and A has declared C to be its descendant so we infer that the only descendant relationship has to be via B and we infer that there is a parent child relationship between A and B. We redraw the graphic to show the confirmed (D-B and B-C) links and the unconfirmed (B-A) links, as illustrated in FIG. 13. By illustrating unconfirmed links on a map we alert the user that there is a potential data inconsistency problem which may warrant further investigation.

As may now be appreciated, the procedure illustrated above is one of many approaches to confirm linkages and that there are many variations of data configurations to be considered. Because of the configuration of the PAIR data where “Child Continuity Data” does not explicitly show relationship, for this particular embodiment, an approach is employed to confirm links based on “Parent Continuity Data”. In other data sources, relationships may be explicit or different ambiguities may be present, and other approaches for “confirming” linkages may be applied. Likewise, the set of visual operations just described may be implemented in a more streamlined fashion in practice. This visual approach is shown here merely for purposes of illustration.

Typically, as a result of American Inventors Protection Act of 1999, patent applications filed in the US now are published 18 months after filing. These published applications become publicly available prior art which may be cited by other patents. In one embodiment, it may be desirable show these relationships in a graphic. FIG. 14, for example, shows a graphic with an issued US patent citing a Published US application.

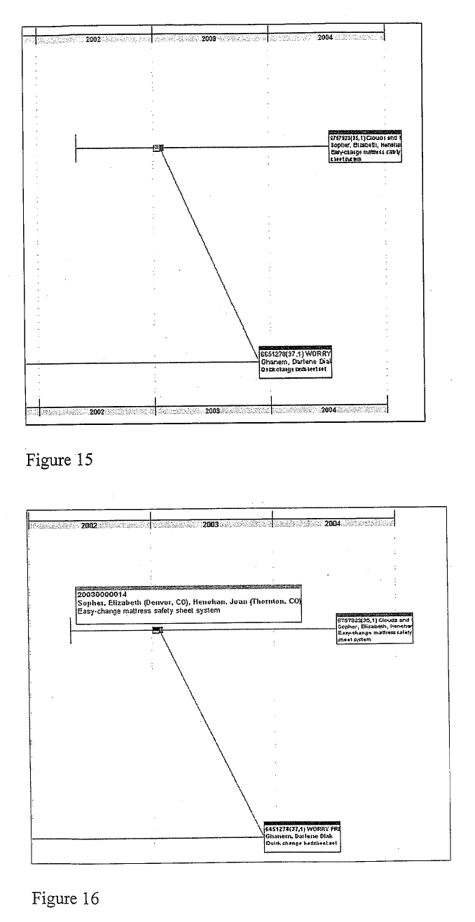

Likewise, a published application may become an issued patent. It therefore may be desirable in an embodiment to show both the original published application and the resulting issued patent in a clear and understandable manner. FIG. 15 shows a method of illustrating this, although claimed subject matter is not limited in scope in this respect. The patent in the bottom right portion of the map has a citation line to a small box on the tail of the patent shown in the upper portion of the map. This “small box” is the published patent application which resulted in the patent shown on the right end of the “tail”. In this embodiment, a cursor hovering over the “small box” shows an expansion of the box as shown in FIG. 16. Further, in this embodiment, right clicking on the expanded box provides an Action Menu to obtain further information on the published application, as previously described.

On a graphic, it may be useful to identify and select items that are commonly connected or associated. For a starting set of one or more patents, for example, one useful type of connection may include all patents that are cited by the starting set or patents that cite a patent in the starting set. In one embodiment, a starting set may be selected via a user interface. Once the interconnected items are selected, the combined set of selected items may be used as a new starting set. A related concept is to select all items that share an attribute with a starting item. For example, in one embodiment, a context menu may allow a user to select all patents that have, for example, the same assignee, patent class, examiner, etc. Many other variations are of course possible and included within the scope of claimed subject matter.

In another embodiment, a note may be designated by a visual marker using HTML without the use of a browser-based plug-in for visual rendering. The marker may be a graphic including a part or entire note text in its visualization. The marker is not located in a fixed configuration, such as the grid-like layout of the detail, icon or filmstrip view of a file directory on a Windows computer system. Thus, a user, interacting with the browser in such an embodiment may move a pointing device over the marker so that a flyover appears showing the note.

In still another embodiment, a method of visualizing, via a graphic, a relationship between a patent or published application to its peer patents or published applications, for example, within the US Patent Classification (USPC) system, may be provided. The USPC is a hierarchical classification system. It may be visualized as a tree where the main classes are top-level nodes, and the class/subclass pairs are lower-level nodes. A patent may be associated with one node on such a class tree, along with its peers in the same subclass.

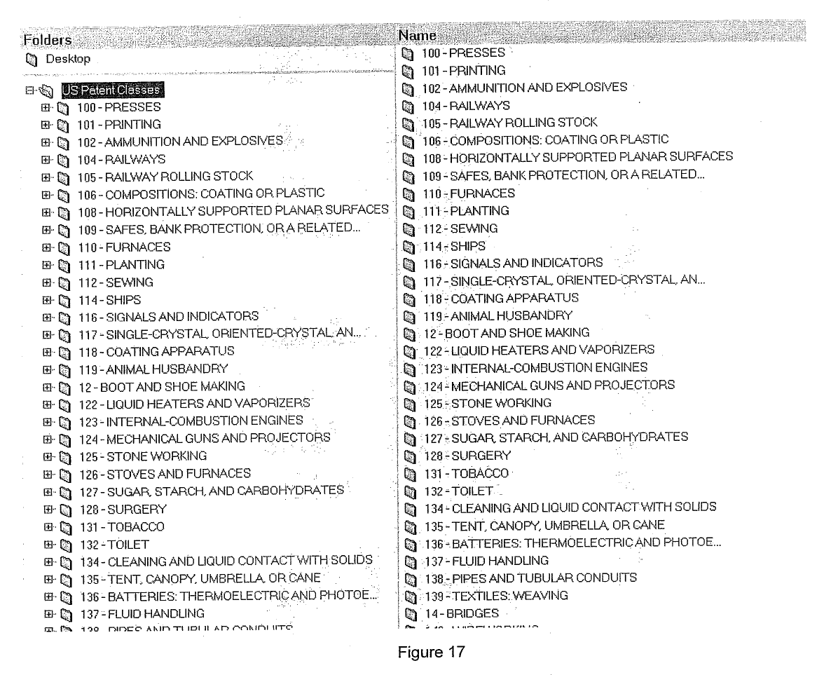

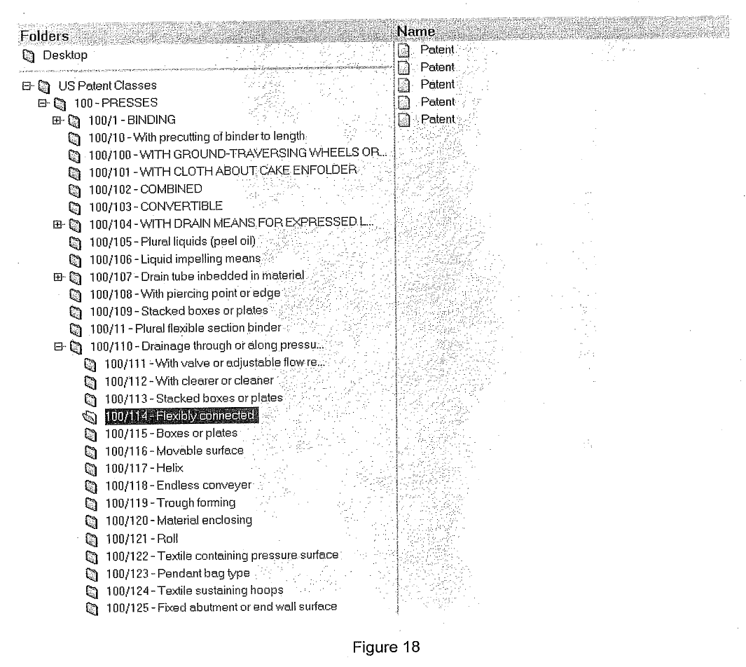

For example, in one particular embodiment, a class tree graphical user interface (GUI) may be employed to display the hierarchical USPC system on a computer screen or web page, similar to the way a computer file system is commonly displayed, as illustrated in FIG. 17. Referring to FIG. 18, a folder icon on a class tree GUI represents a class pair node in this particular embodiment. A document icon represents a patent within that class pair in this example. A class pair node may be displayed in a closed state or in an open state, which shows the patents and subclasses contained within the node. If a user clicks on the (+/−) icon of a class pair node, the class pair node toggles between the open and closed state for this particular embodiment.

A class tree GUI may show the entire USPC hierarchy or a subset of the USPC hierarchy. A subset is useful for showing the relationships among of a set of patents within the USPC hierarchy. In this particular embodiment, a complete class tree may be pruned of empty nodes that contain no patents or subclasses in the set so that the only nodes displayed are those that contain one or more patents in the set, or that contain subclasses containing patents in the set. A class tree GUI, such as this particular embodiment, for example, therefore, enables a user to quickly identify peer patents in the set that are in close proximity within the USPC hierarchy to a subject patent, such as, for example, patents on the same branch or adjacent branches of a class tree.

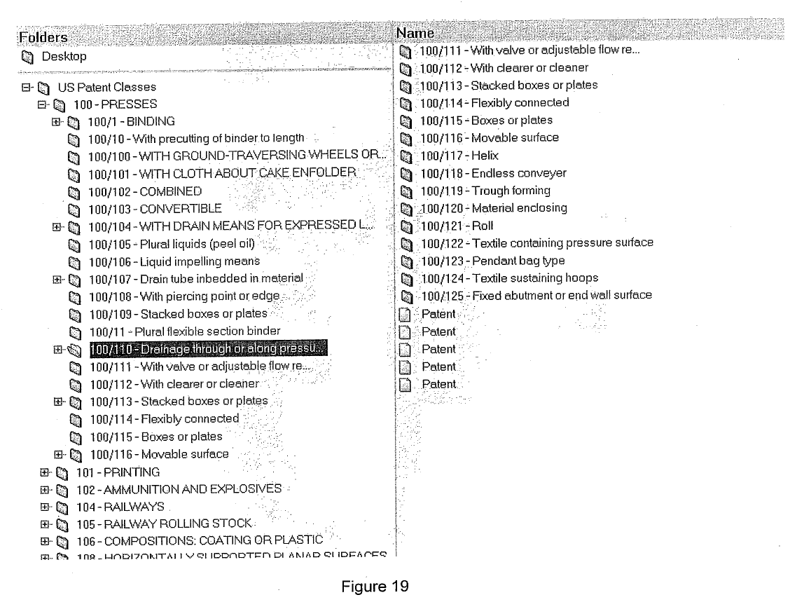

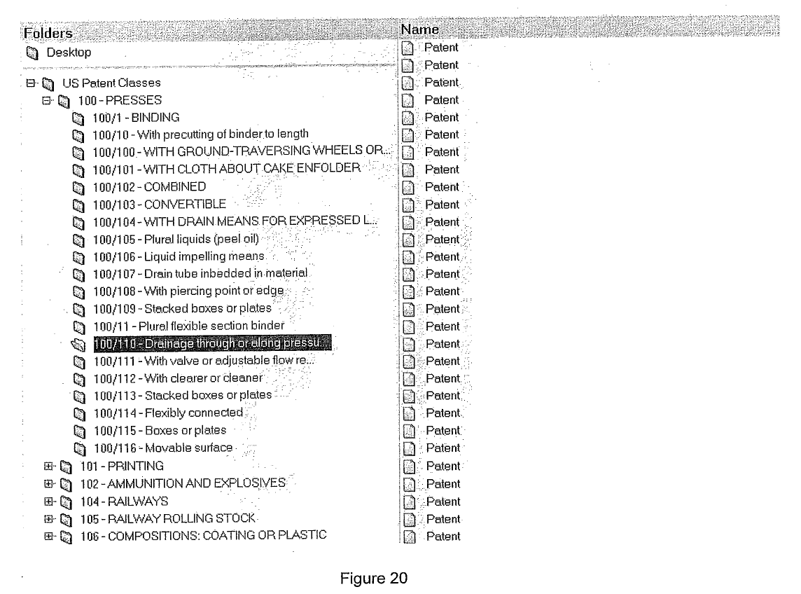

A class tree GUI may also be used to visualize the operation of “node flattening,” in this particular embodiment. For this particular embodiment, this refers to removing from the graphic subclasses of the hierarchy that are below a node. In this embodiment, this “flattened” node is displayed as a non-hierarchical list of patents directly contained in that node's subclass as well as those contained in subclasses, sub-sub classes, etc. FIG. 19 shows a selected node displayed before flattening and FIG. 20 shows it after flattening for this embodiment. Node flattening may be employed to divide a set of patents into several non-overlapping bins according to proximity on the class tree, such that a bin encompasses a compact region of the class tree. In this context, auto-binning refers to a process for dividing of a set of patents into non-overlapping regional bins of approximately equal size.

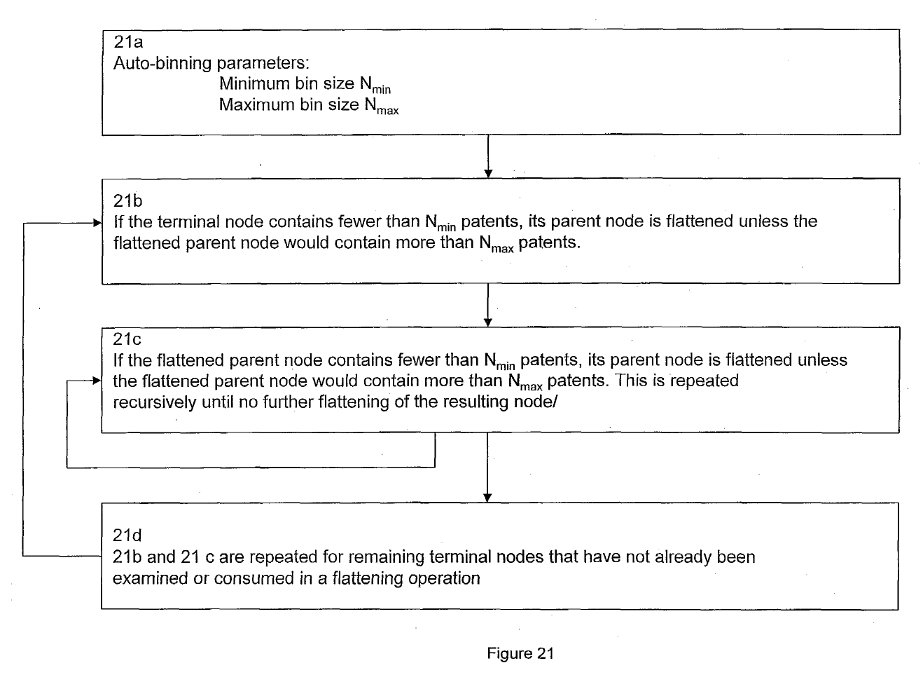

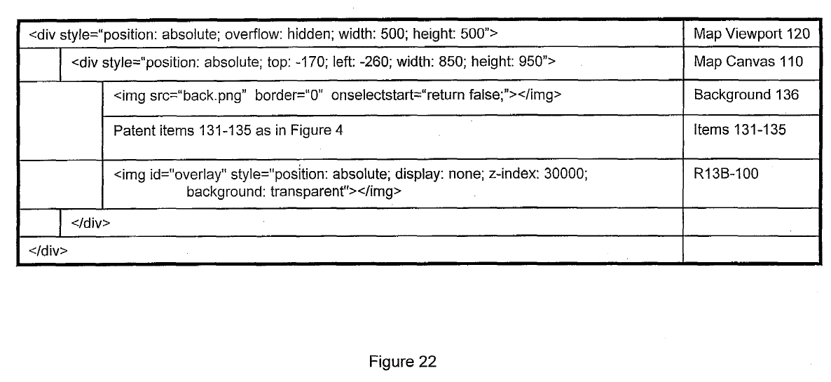

One particular auto-binning process is illustrated in FIG. 21, although this is merely one embodiment and claimed subject matter is not necessarily limited to this particular embodiment. This particular embodiment employs 2 parameters: a minimum bin size Nₘᵢₙ, and a maximum bin size Nₘₐₓ (21a). In this embodiment, first terminal node of the class tree is processed as follows: If the terminal node includes fewer than Nₘᵢₙ patents, its parent node is flattened unless the flattened parent node would contain more than Nₘₐₓ patents (21b). If the flattened parent node includes fewer than Nₘᵢₙ patents, its parent node is flattened unless the flattened parent node would include more than Nₘₐₓ patents (21c). The previously operation is repeated recursively until no further flattening of the resulting node is required. The two previous operations are repeated for remaining terminal nodes that have not already been examined or consumed in a flattening operation (21d).

Various metrics have been applied to evaluate a subject patent, for example, the number of independent claims, the number of citations by other patents, the time to expiration, etc. However, the mean value of such metrics may vary widely between one class and another. Thus, it may be desirable in some situations to report metrics for a patent relative to those of its peers on the class tree. For example, reporting a subject patent A with 6 citations in a region of the class tree with a mean citation rate of 2 may provide more insight than reporting a subject patent B with 15 citations in a region of the class tree with a mean citation rate of 18. An auto-binning technique, such as the embodiment described above, for example, may therefore be employed to define a peer group against which a subject patent may be evaluated. Metrics for a subject patent are then reported relative to mean metrics for patents in the same bin. The minimum bin size may likewise be set or modified to provide meaningful statistics.

Likewise, it may be desirable for particular embodiments to have the ability to for finding documents similar to a starting document or documents based on textual content via a semi-automated approach. The particular embodiment described here uses semi-automated approaches, described in more detail below, to search a pool of electronic documents to find those documents in the pool whose text contains specific concepts. A human examiner, for example, may begin by identifying relevant concepts in the starting documents, and may use a combination of manual and semi-automated processes to generate a set of concept filters for searching a pool to find documents with similar concepts.

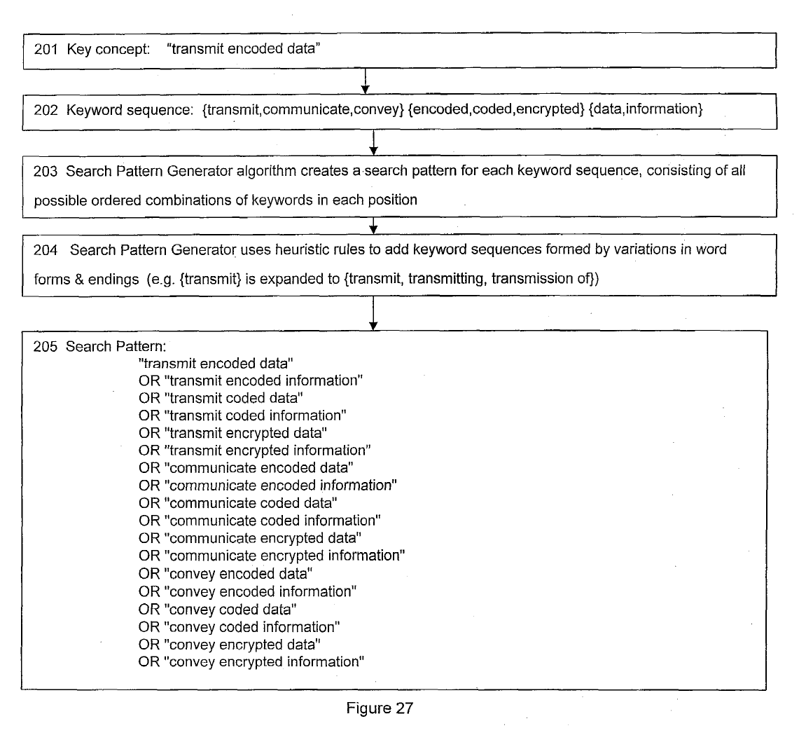

Referring to FIG. 27, by examining starting document(s), the human examiner identifies a set (2 or more) of concepts, shown by 201, in the document text, or a particular section of the document. A concept may be expressed as a keyword sequence, shown by 202, where a position in a word sequence may be occupied by any of several possible synonymous words, or roughly-synonymous words in the context of the particular concept. A Search Pattern Generator process, shown by 203, may create a search pattern for keyword sequences, comprising, here, possible ordered combinations of keywords in various position. Search Pattern Generator, shown by 204, may also use heuristic rules to add in keyword sequences formed by variations in word forms, word endings and the like. The search pattern may be expressed in a syntax (e.g., SQL statement) for searching an electronic database.

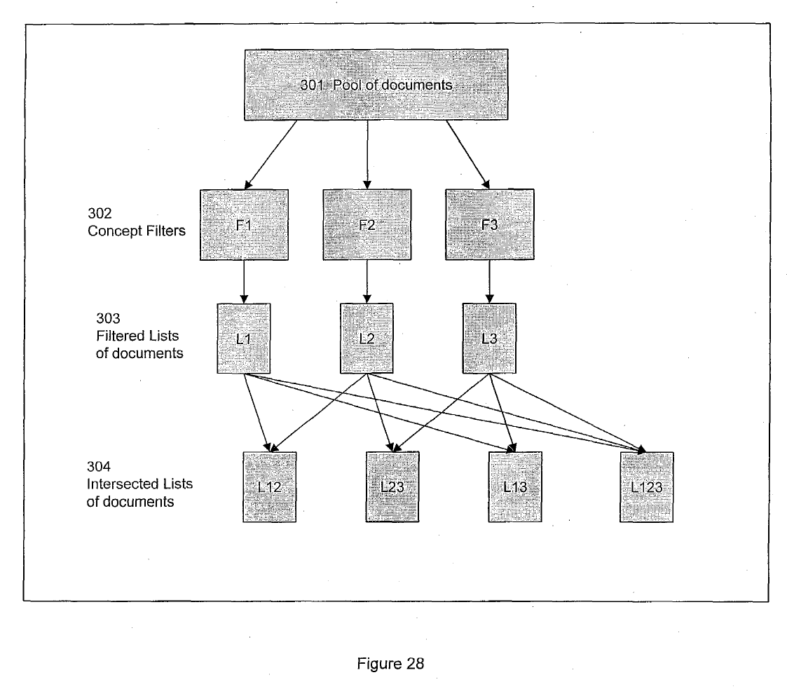

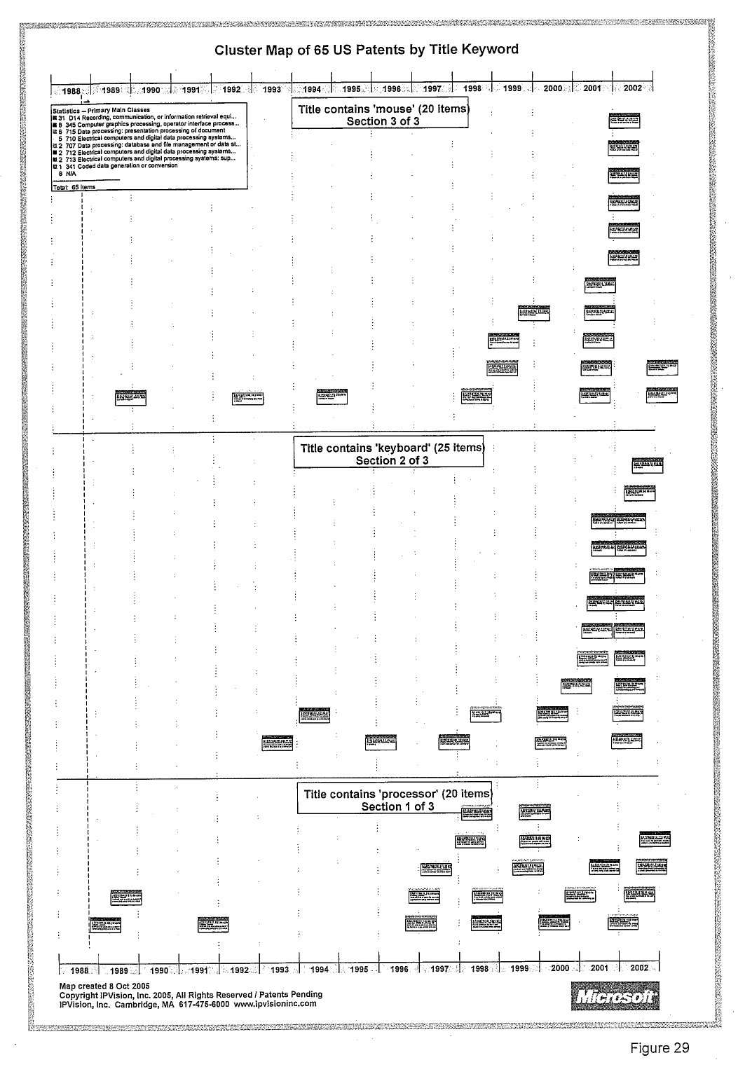

Referring to FIG. 28, an iterative process may be applied to the set of Concept Filters. A Concept Filter, shown by 302, is applied to a pool of documents, shown by 301 and results in a filtered list of documents, shown by 303, meeting desired criteria. The filtered lists, shown by 303 and intersected combinations of filtered lists, shown by 304, are presented to the human examiner. Based on a variety of factors, including relative sizes of filtered lists, an examiner may makes a judgment about the effectiveness of the Concept Filters and may decide to expand the keywords within one or more of the Concept Filters. For example, if 3 concepts were identified (Concept 1, Concept 2, Concept 3), and L12 includes an adequate number of documents, but L123 is very small or empty, the examiner may review the documents in L12 that are not in L123. If he discovers that some of the documents in L12 include Concept 3, the examiner may expand the keyword list of Concept 3 to include these “missed” documents. An initial search pool may comprise documents with a known relationship to the starting document(s), such as directly referenced documents, reference “cousins”, documents by same author, documents in same “class,” as a technique to hone the Concept Filters. After some modification resulting in improved Concept Filters according to the methodology presented here, the process may then be more effectively employed against a larger pool of documents.

Another embodiment of a graphic includes a workflow cluster graphic and the approach described above for locating similar documents may be applied as part of a process of producing such a graphic, although claimed subject matter is not limited in scope in this respect. Here, we refer to a graphic that shows related items on a common timeline. The items are vertically separated sections based on the category of the item. The sections are determined by an attribute of the item such that groups of items are related through workflow. This particular embodiment, for example, may allow a portfolio manager/user to view activities surrounding a group of documents over time. These documents could be IP matters with different document categories, such as issued patents, pending patents, docketing records, invention disclosures, USPTO office actions, etc., or they may comprise other categories of documents/data, such as technical journal articles, financial documents, HR (human resource) documents, SEC filings, etc. The different categories of documents typically share a common timeline.

Relationships between the various documents may be depicted graphically by connecting items representing the documents. Connections that are possible for other graphic embodiments, such as those previously described, that may not vertically separated may also be employed in such an embodiment. For example, documents that represent a specific IP matter or which share a common inventor may be connected together in a time sequence. The connections may be confined to a vertical section or they may span items between different sections. Relationships may also be depicted by the shape or color of the items for some embodiments.

Yet another embodiment, related to the previous one, may allow users to start with a baseline layout of different categories of documents, and visualize/detect patterns of relationships overlaid onto the baseline graphic. For example, this may be employed to detect a pattern of published papers/journal articles in relation to application filing dates by the same authors/inventors. This might identify possible “publish before filing” issues or inequitable conduct situations, for example. There are other additional patterns that may have business impact that could likewise be detected.

As one possible example, a Workflow by Document Type graphic might be created or constructed. Individual sections, e.g., top to bottom, may show the documents for different phases of prosecution of an IP Matter for a US patent, for example. In one such embodiment, sections might include, for example, IP Matters (e.g., docketing records), Unpublished US applications, Published US patent applications and issued US patents.

Continuing with this example, a user may select to have some or all related documents automatically found, such as by techniques or approaches previously discussed, although claimed subject matter is not limited in scope in this respect. For example, a user may begin with a list of IP Matters. The items that correspond to such a list may be shown on a graphic with their body shaded in, for example. For example, IP Matters may comprise an initial set of docketing records. In the process of creating a graphic, related documents that evolved from those IP matters may be automatically or semi-automatically found and displayed in their appropriate sections. The user could have also started with a list of that included US applications, instead. In that case, the processing could have found and displayed related IP Matters, Unpublished US applications and US patents. Of course, this is merely one example and claimed subject matter is not limited in scope to this example embodiment.

Here, FIG. 29 shows an alternate embodiment, a Workflow by Source List graphic, which shows items from different lists in the different sections. The example shown here shows the results of three separate keyword searches over a patent portfolio, to find the three lists of patents whose title contained the words “mouse”, “keyboard” and “processor”, respectively. One advantage of the embodiment shown in FIG. 29 is that a user may determine what groups of items to compare, without a predetermined-relationship between items of the individual lists. If viewed in an interactive mode through a browser, such a graphic may allows user a technique for more efficient sampling and review of the individual items. Again, this is merely one example and claimed subject matter is not limited in scope to this example embodiment.

In still another embodiment, a graphic may show IP workflow documents (e.g., issued patents, pending patents, docketing records, invention disclosures, USPTO office actions, etc) for one or more disclosures of an IP matter or matters on a common timeline. The various documents may be connected by lines, for example, illustrating progress over time.

Likewise, as previously alluded to, in some embodiments, it may be desirable to combine graphics and analytic functionality, such as embodiments previously described with embodiments described in the previously cited US patent applications, assigned to assignee of the present patent application. The analytic functionality and graphics may be made interoperable, and also have the ability to be recursive. For example, from a graphic showing a family of IP, one might generate forward or backward Citation graphics from one or more of the patents on the family graphic. Similarly, one might combine a family graphic and a workflow graphic or inventor graphic. Likewise, “scripting capability” may permit one to “string” together analytic and graphic operations to produce “compound functions”, e.g., a series of recursive operations applied to lists of documents or IP assets, for example.

Yet another embodiment employing a graphic may employ a mechanism to draw attention to a designated group of map items though “blinking.” In one possible implementation, successively hiding covering/uncovering items with colored shapes may be employed. Blinking turns “on” to cover the designated items and “off” to uncover them. Further, in such an embodiment, the design and color of the shape that covers an item may also convey information about the item, making it easier for an observer to extract information. One particular approach or embodiment to implementing such blinking in HTML and Javascript is described, although other approaches and implementations are possible and included within the scope of claimed subject matter.

There exist some web technologies that can be used to achieve a blinking effect. Simple image animation, such as blinking or animating parts of an image, is commonly achieved by creating a GIF format file that contains information about time sequencing of an image and its sections. A disadvantage of using GIF files is that the file includes the full contents of the image and its overlays. For large images, generating a large image and sending it from the server to the browser occurs. Most commonly, therefore, GIF files are used for smaller images, such as banner advertisements, with more complex animation done with browser plug-ins, such as Flash.

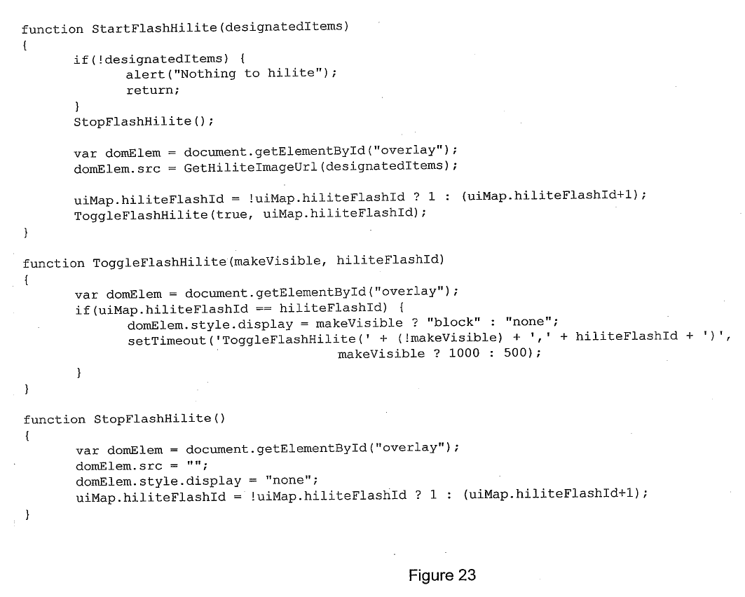

An effective and efficient approach to blinking items on a graphic display by a browser is to instead create a separate image that is to overlay what may be displayed. Creating a blinking effect in this manner with reference to HTML and JavaScript is illustrated respective in FIG. 22 and in FIG. 23. The procedure starts with a call to the JavaScript function StartFlashHilite( ) which calls GetHiliteImageUrl( ) which, in turn, sends a request to the server to create an overlay image. A list of designated items may be sent to the server as a separate HTTP request or by encoding the list into the image URL. The server generates an image with the desired overlay patterns for the designated items. The server uses an image format that may include transparent pixels. By default, all pixels are rendered transparent, except the ones that comprise the shapes intended to cover designated map items. The use of transparent pixels allows an image to be placed over graphic content without hiding the content. Some image formats allow the level of transparency to be adjusted using an opacity parameter. Decreasing the transparency may therefore fade underlying features if a blink state is “on”, taking attention away from those features. For example, in one particular embodiment, a 32 bit PNG file format may be used to create an overlay image. Although other formats might be used, this format may be convenient because it is supported with transparent pixels in typical browsers.

The “src” attribute of the overlay <img>, FIG. 23, is set to the URL returned by GetHiliteImageUrl( ). This results in the <img> contents being the overlay image. Note that in this embodiment the “z-index” attribute of the overlay <img> is greater than that of any other sibling element in the <div>. Thus, image is effectively on top of other graphic elements. However, note that the “display” attribute is initialized to “none” so that the <img> is not visible yet. Once the <img>, FIG. 23, is set to include the overlay image, ToggleFlashHilite( ) is called to initiate the flashing. ToggleFlashHilite( ) uses the built-in JavaScript function setTimeout( ) to create a callback timer that allows it to make a <img> visible for 1000 milliseconds and then to hide it for 500 milliseconds. For showing/hiding of the <img>, therefore, setting of the “display” attribute to “block” shows the image and “none” hides it, in this particular embodiment. The blinking may be stopped by calling StopFlashHilite( ), which hides the overlay image, and then turns sets the “hiliteFlashId” parameter so that ToggleFlashHilite( ) will cease calling setTimeout( ) and thereby end the blinking cycle.

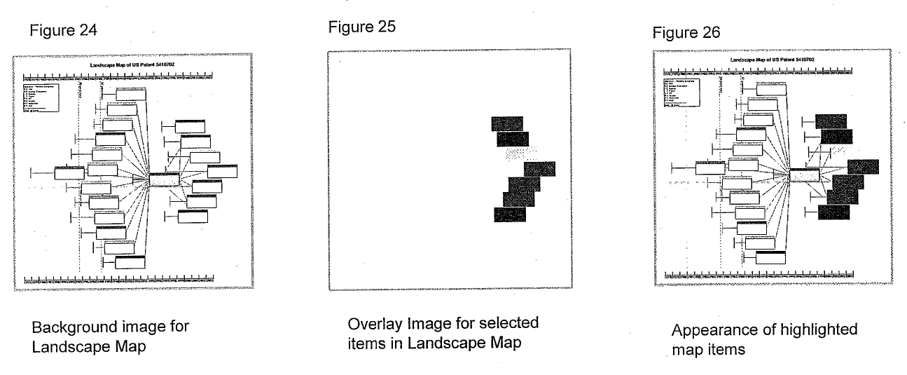

FIGS. 24 through 26 show an example and its overlay image. FIG. 24 shows a screen grab of a graphic with rectangular boxes corresponding to individual patent items. FIG. 25 shows the overlay image as sent from the server to the browser. FIG. 26 shows the original graphic with the overlay superimposed. Note that features are visible except for the areas where the overlay has shapes. Also note that, the color of the shapes may be to correspond to particular items. The blinking effect is achieved by showing the observer the contents in FIG. 26 for one second and then hiding the overlay for half a second to show the original contents in FIG. 24, and then repeating the cycle.

There are several advantages to blinking as described for this particular embodiment. The overlay image is independent of the HTML elements of the graphic so the overlay shapes may be larger or smaller than the items that are covered. The design and color of the shape may be selected to convey additional information about the attributes of the items that is covered. Furthermore, using a single overlay image may have the beneficial result that flashing is synchronized. Other methods that attempt to by altering attributes of the designated item elements directly may result in the items blinking in an unsynchronized or unpredictable manner. Modern file formats, such PNG files are efficient for encoding simple shapes in an image that is otherwise blank or transparent. The result is a small PNG file that can be quickly sent from server to the browser, making the onset of the blinking be faster. Using a simple image with a transparent pixel can take advantage of efficient rendering by a computer system. This makes the blinking “on” and “off” cycles transition more quickly, making the blinking seem more effective for the observer.

It will, of course, be understood that, although particular embodiments have just been described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, claimed subject matter is not limited in scope to this example.

In the preceding description, various aspects of claimed subject matter have been described. For purposes of explanation, specific numbers, systems and configurations were set forth to provide a thorough understanding of the claimed subject matter. However, it should be apparent to one skilled in the art having the benefit of this disclosure that claimed subject matter may be practiced without the specific details. In other instances, well-known features were omitted or simplified so as not to obscure claimed subject matter. While certain features have been illustrated and described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method comprising:
displaying a graphic depicting a family relationship among intellectual property (IP) assets substantially in accordance with data from one or more sources.

2. The method of claim 1, wherein said graphic is created by a client browser at least with respect to employing data regarding the family relationship.

3. The method of claim 1, wherein said intellectual property assets include patents and/or patent applications.

4. The method of claim 3, wherein said intellectual property assets include US patents and/or patent applications.

5. The method of claim 1, wherein said graphic further depicts relationships regarding forward and/or backward citations for at least some of the IP assets.

6. The method of claim 1, wherein said data to construct said graphic is obtained by traversing links of said one or more data sources.

7. The method of claim 6, wherein said one or more data sources comprises at least the Patent Application Information Retrieval (PAIR) System and traversing links comprises traversing continuity data links of the PAIR system.

8. The method of claim 1, wherein data inconsistencies or anomalies in the family relationship are depicted differently than other aspects of the family relationship.

9. The method of claim 1, wherein aspects of the family relationship are depicted using blinking and/or highlighting.

10. The method of claim 9, wherein said blinking is implemented by creating a separate overlay graphic that includes pixels that are transparent at least a portion of time.

11. A method comprising:
displaying a graphic depicting a class relationship among intellectual property (IP) assets substantially in accordance with data from one or more sources.

12. The method of claim 11, wherein said graphic is created by a client browser at least with respect to employing data regarding the class relationship.

13. The method of claim 11, wherein said intellectual property assets include patents and/or patent applications.

14. The method of claim 13, wherein said intellectual property assets include US patents and/or patent applications.

15. The method of claim 11, wherein said graphic further depicts relationships regarding forward and/or backward citations for at least some of the IP assets.

16. The method of claim 11, wherein aspects of the class relationship are depicted using blinking and/or highlighting.

17. The method of claim 16, wherein said blinking is implemented by creating a separate overlay graphic that includes pixels that are transparent at least a portion of time.

18. The method of claim 11, wherein said graphic depicts a class relationship between a particular IP asset and peer IP assets in the same class and/or subclass.

19. A method comprising:
displaying a graphic depicting a workflow relationship among intellectual property (IP) assets substantially in accordance with data from one or more sources.

20. The method of claim 19, wherein said graphic is created by a client browser at least with respect to employing data regarding the workflow relationship.

21. The method of claim 19, wherein said intellectual property assets include patents and/or patent applications.

22. The method of claim 21, wherein said intellectual property assets include US patents and/or patent applications.

23. The method of claim 19, wherein said graphic further depicts relationships regarding forward and/or backward citations for at least some of the IP assets.

24. The method of claim 19, wherein aspects of the workflow relationship are depicted using blinking and/or highlighting.

25. The method of claim 24, wherein said blinking is implemented by creating a separate overlay graphic that includes pixels that are transparent at least a portion of time.

26. An article comprising: a storage medium having stored thereon instructions that, if executed, result in execution of a method comprising:
displaying a graphic depicting a family relationship among intellectual property (IP) assets substantially in accordance with data from one or more sources.

27. The article of claim 26, wherein said instructions, if executed, further result in said graphic being created by a client browser at least with respect to employing data regarding the family relationship.

28. The article of claim 26, wherein said instructions, if executed, further result in said intellectual property assets including patents and/or patent applications.

29. The article of claim 28, wherein said instructions, if executed, further result in said intellectual property assets including US patents and/or patent applications.

30. The article of claim 26, wherein said instructions, if executed, further result in said graphic further depicting relationships regarding forward and/or backward citations for at least some of the IP assets.

31. The article of claim 26, wherein said instructions, if executed, further result in said data to construct said graphic being obtained by traversing links of said one or more data sources.

32. The article of claim 31, wherein said instructions, if executed, further result in said one or more data sources comprising at least the Patent Application Information Retrieval (PAIR) System and said traversing links comprising traversing continuity data links of the PAIR system.

33. The article of claim 26, wherein said instructions, if executed, further result in data inconsistencies or anomalies in the family relationship being depicted differently than other aspects of the family relationship.

34. The article of claim 26, wherein said instructions, if executed, further result in aspects of the family relationship being depicted using blinking and/or highlighting.

35. The article of claim 34, wherein said instructions, if executed, further result in said blinking being implemented by creating a separate overlay graphic that includes pixels that are transparent at least a portion of time.

36. An article comprising: a storage medium having stored thereon instructions that, if executed, result in execution of a method comprising:
displaying a graphic depicting a class relationship among intellectual property (IP) assets substantially in accordance with data from one or more sources.

37. The article of claim 36, wherein said instructions, if executed, further result in said graphic being created by a client browser at least with respect to employing data regarding the class relationship.

38. The article of claim 36, wherein said instructions, if executed, further result in said intellectual property assets including patents and/or patent applications.

39. The article of claim 38, wherein said instructions, if executed, further result in said intellectual property assets including US patents and/or patent applications.

40. The article of claim 36, wherein said instructions, if executed, further result in said graphic further depicting relationships regarding forward and/or backward citations for at least some of the IP assets.

41. The article of claim 36, wherein said instructions, if executed, further result in aspects of the class relationship being depicted using blinking and/or highlighting.

42. The article of claim 36, wherein said instructions, if executed, further result in said blinking being implemented by creating a separate overlay graphic that includes pixels that are transparent at least a portion of time.

43. The article of claim 36, wherein said instructions, if executed, further result in said graphic depicting a class relationship between a particular IP asset and peer IP assets in the same class and/or subclass.

44. An article comprising: a storage medium having stored thereon instructions that, if executed, result in execution of a method comprising:
displaying a graphic depicting a workflow relationship among intellectual property (IP) assets substantially in accordance with data from one or more sources.

45. The article of claim 44, wherein said instructions, if executed, further result in said graphic being created by a client browser at least with respect to employing data regarding the workflow relationship.

46. The article of claim 44, wherein said instructions, if executed, further result in said intellectual property assets including patents and/or patent applications.

47. The article of claim 46, wherein said instructions, if executed, further result in said intellectual property assets including US patents and/or patent applications.

48. The article of claim 44, wherein said instructions, if executed, further result in said graphic further depicting relationships regarding forward and/or backward citations for at least some of the IP assets.

49. The article of claim 44, wherein said instructions, if executed, further result in aspects of the workflow relationship being depicted using blinking and/or highlighting.

50. The article of claim 23, wherein said instructions, if executed, further result in said blinking being implemented by creating a separate overlay graphic that includes pixels that are transparent at least a portion of time.

51. An apparatus comprising: a computing platform; said computing platform being adapted to display a graphic depicting a family relationship among intellectual property (IP) assets substantially in accordance with data from one or more sources.

52. The apparatus of claim 51, wherein said computing platform is adapted to create said graphic via a client browser at least with respect to data regarding the family relationship.

53. The apparatus of claim 51, wherein said computing platform is adapted so as to include patents and/or patent applications in said graphic.

54. The apparatus of claim 53, wherein said computing platform is adapted so as to include US patents and/or patent applications in said graphic.

55. The apparatus of claim 51, wherein said computing platform is adapted to further depict relationships regarding forward and/or backward citations to at least some of the IP assets.

56. The apparatus of claim 51, wherein said computing platform is adapted to construct said graphic from data obtained by traversing links of said one or more data sources.

57. The apparatus of claim 56, wherein said computing platform is adapted to obtain said data from the Patent Application Information Retrieval (PAIR) System by traversing continuity data links of the PAIR system.

58. The apparatus of claim 51, wherein said computing platform is adapted to depict data inconsistencies or anomalies in the family relationship differently than other aspects of the family relationship.

59. The apparatus of claim 51, wherein said computing platform is adapted to depict aspects of the family relationship using blinking and/or highlighting.

60. The apparatus of claim 59, wherein said computing platform is adapted to create a separate overlay graphic that includes pixels that are transparent at least a portion of time.

61. An apparatus comprising: a computing platform; said computing platform being adapted to display a graphic depicting a class relationship among intellectual property (IP) assets substantially in accordance with data from one or more sources.

62. The apparatus of claim 61, wherein said computing platform is adapted to create said graphic with a client browser at least with respect to employing data regarding the class relationship.

63. The apparatus of claim 61, wherein said computing platform is adapted to include patents and/or patent applications in said graphic.

64. The apparatus of claim 63, wherein said computing platform is adapted to include US patents and/or patent applications in said graphic.

65. The apparatus of claim 61, wherein said computing platform is adapted to depict relationships regarding forward and/or backward citations for at least some of the IP assets.

66. The apparatus of claim 61, wherein said computing platform is adapted to depict aspects of the class relationship using blinking and/or highlighting.

67. The apparatus of claim 61, wherein said computing platform is adapted to implement said blinking by creating a separate overlay graphic that includes pixels that are transparent at least a portion of time.

68. The apparatus of claim 61, wherein said computing platform is adapted to depict a class relationship between a particular IP asset and peer IP assets in the same class and/or subclass.

69. An apparatus comprising: a computing platform; said computing platform being adapted to display a graphic depicting a workflow relationship among intellectual property (IP) assets substantially in accordance with data from one or more sources.

70. The apparatus of claim 69, wherein a computing platform; said computing platform being adapted to create said graphic using a client browser at least with respect to employing data regarding the workflow relationship.

71. The apparatus of claim 69, wherein said computing platform is further adapted so as to include patents and/or patent applications in said graphic.

72. The apparatus of claim 71, wherein said computing platform is further adapted so as to include US patents and/or patent applications in said graphic.

73. The apparatus of claim 69, wherein said computing platform is further adapted to depict relationships regarding forward and/or backward citations for at least some of the IP assets.

74. The apparatus of claim 69, wherein said computing platform is further adapted to depict said workflow relationship using blinking and/or highlighting.

75. The apparatus of claim 75, wherein said computing platform is further adapted to implement said blinking by creating a separate overlay graphic that includes pixels that are transparent at least a portion of time.
